(19) United States
(12) Patent Application Publication
(10) Pub. No.: US 2025/0342366 A1
(43) Pub. Date: Nov. 6, 2025

(54) METHOD AND SYSTEM FOR EXPLAINING DECODER-ONLY SEQUENCE CLASSIFICATION MODELS USING INTERMEDIATE PREDICTIONS

(71) Applicant: JPMorgan Chase Bank, N.A., New York, NY (US)

(72) Inventors: Sanjay KARIYAPPA, Mountain View, CA (US); Freddy LECUE, Mamaroneck, NY (US); Saumitra MISHRA, London (GB); Christopher POND, Kent (GB); Aviral JOSHI, Seattle, WA (US); Saket SHARMA, New York, NY (US); Daniele MAGAZZENI, London (GB); Manuela VELOSO, New York, NY (US)

(73) Assignee: JPMorgan Chase Bank, N.A., New York, NY (US)

(21) Appl. No.: 18/654,641

(22) Filed: May 3, 2024

(51) Int. Cl. G06N 5/022

(52) U.S. Cl. CPC G06N 5/022

(57) ABSTRACT

Methods and systems for computing input attributions to accurately explain predictions of decoder-only sequence classification models are provided. The method includes: receiving a set of inputs to the decoder-only sequence classification model; generating, based on the first set of inputs, a perturbed version of the set of inputs; sampling a binary mask from a predetermined masking distribution; generating a group of masked versions of the perturbed set of inputs by applying the binary mask to the perturbed set of inputs; generating, based on the group of masked versions of the perturbed set of inputs, corresponding sets of intermediate predictions that correspond to the decoder-only sequence classification model; computing, based on the sets of intermediate predictions, a set of input attributions; and determining, based on the set of input attributions, an explanation that relates to a prediction of the decoder-only sequence classification model.

### BACKGROUND

### 1. Field of the Disclosure

This technology relates to methods and systems for computing input attributions to accurately explain predictions of decoder-only sequence models by using intermediate predictions by evaluating the models at different points in the input sequence.

### 2. Background Information

Large language models (LLMs) based on the decoder-only Transformer architecture have gained widespread adoption over the past few years with a burgeoning open-source community creating increasingly performant models. Owing to their impressive generalization capability, these models can be used directly for zero-shot and/or few-shot classification tasks, or indirectly to generate pseudo-labels to train custom models. They also serve as base models that can be fine-tuned on specific classification tasks, achieving performance that matches and/or surpasses other architectures. There is also an ability to fine-tune LLMs on custom data by using commercially available application programming interfaces (APIs) that are designed for performing such tasks.

With the growing adoption of these LLMs in critical applications such as health care and finance, there is a strong need to provide accurate explanations to improve trust in predictions made by such models. Input attribution is a form of explanation that addresses this need by highlighting input features that support or oppose the prediction of the model. This can be used to easily evaluate the correction of a prediction of a particular model, debug model performance, perform feature selection, and also to improve model performance by guiding the model to focus on the relevant parts of the input.

While there have been previous works that relate to the subject of generating input attributions using input perturbations, relevance propagation, attention scores, or gradients, they are either expensive or yield relatively low-quality attributions that do not accurately reflect the behavior of the model. Accordingly, there is a need for a mechanism for computing input attributions to accurately explain predictions of decoder-only sequence models by using intermediate predictions by evaluating the models at different points in the input sequence.

### SUMMARY

The present disclosure, through one or more of its various aspects, embodiments, and/or specific features or sub-components, provides, inter alia, various systems, servers, devices, methods, media, programs, and platforms for methods and systems for computing input attributions to accurately explain predictions of decoder-only sequence models by using intermediate predictions by evaluating the models at different points in the input sequence.

According to an aspect of the present disclosure, a method for obtaining an explanation of a prediction of a decoder-only sequence classification model is provided. The method is implemented by at least one processor. The method includes: receiving a first set of inputs to the decoder-only sequence classification model; generating, based on the first set of inputs, a first set of intermediate predictions that correspond to the decoder-only sequence classification model; estimating, based on the first set of intermediate predictions, a second set of intermediate predictions that relates to a perturbed version of the first set of inputs; computing, based on the second set of intermediate predictions, a first set of input attributions; and determining, based on the first set of input attributions, a first explanation that relates to a prediction of the decoder-only sequence classification model.

The computing of the first set of input attributions may include computing a set of respective differences between successive pairs of intermediate predictions within the second set of intermediate predictions.

According to another aspect of the present disclosure, a method for obtaining an explanation of a prediction of a decoder-only sequence classification model is provided. The method is implemented by at least one processor. The method includes: receiving a first set of inputs to the decoder-only sequence classification model; generating, based on the first set of inputs, a perturbed version of the first set of inputs; sampling a binary mask from a predetermined masking distribution; generating a plurality of masked versions of the perturbed version of the first set of inputs by applying the binary mask to the perturbed version of the first set of inputs; generating, based on the plurality of masked versions of the perturbed version of the first set of inputs, a corresponding plurality of sets of intermediate predictions that correspond to the decoder-only sequence classification model; computing, based on the plurality of sets of intermediate predictions, a first set of input attributions; and determining, based on the first set of input attributions, a first explanation that relates to a prediction of the decoder-only sequence classification model.

The method may further include filtering the plurality of masked versions of sets of the perturbed version of the first set of inputs in order to remove duplicative masked versions of sets of the perturbed version of the first set of inputs.

The computing of the first set of input attributions may include applying a Kernel SHapley Additive exPlanations (SHAP) algorithm to the filtered plurality of masked versions of sets of the perturbed version of the first set of inputs and the corresponding plurality of sets of intermediate predictions.

The sampling of the binary mask may include applying a predetermined optimization algorithm to the predetermined masking distribution in order to minimize a distance between the filtered plurality of masked versions of sets of the perturbed version of the first set of inputs and a Shapley distribution of subsets of the perturbed version of the first set of inputs.

The computing of the first set of input attributions may include computing the input attributions with respect to word-level input features.

Alternatively, the computing of the first set of input attributions may include computing the input attributions with respect to sentence-level input features.

The method may further include measuring a quality of the first set of input attributions by using an activation study approach that relates to identifying input features that positively influence the prediction of the decoder-only sequence classification model with respect to a predetermined class.

Alternatively, the method may further include measuring a quality of the first set of input attributions by using an inverse activation study approach that relates to identifying input features that negatively influence the prediction of the decoder-only sequence classification model with respect to a predetermined class.

The decoder-only sequence classification model may be a predetermined large language model (LLM).

According to yet another exemplary embodiment, a computing apparatus for obtaining an explanation of a prediction of a decoder-only sequence classification model is provided. The computing apparatus includes a processor; a memory; and a communication interface coupled to each of the processor and the memory. The processor is configured to: receive, via the communication interface, a first set of inputs to the decoder-only sequence classification model; generate, based on the first set of inputs, a perturbed version of the first set of inputs; sample a binary mask from a predetermined masking distribution; generate a plurality of masked versions of the perturbed version of the first set of inputs by applying the binary mask to the perturbed version of the first set of inputs; generate, based on the plurality of masked versions of the perturbed version of the first set of inputs, a corresponding plurality of sets of intermediate predictions that correspond to the decoder-only sequence classification model; compute, based on the plurality of sets of intermediate predictions, a first set of input attributions; and determine, based on the first set of input attributions, a first explanation that relates to a prediction of the decoder-only sequence classification model.

The processor may be further configured to filter the plurality of masked versions of sets of the perturbed version of the first set of inputs in order to remove duplicative masked versions of sets of the perturbed version of the first set of inputs.

The processor may be further configured to compute the first set of input attributions by applying a Kernel SHapley Additive exPlanations (SHAP) algorithm to the filtered plurality of masked versions of sets of the perturbed version of the first set of inputs and the corresponding plurality of sets of intermediate predictions.

The processor may be further configured to perform the sampling of the binary mask by applying a predetermined optimization algorithm to the predetermined masking distribution in order to minimize a distance between the filtered plurality of masked versions of sets of the perturbed version of the first set of inputs and a Shapley distribution of subsets of the perturbed version of the first set of inputs.

The processor may be further configured to perform the computing of the first set of input attributions by computing the input attributions with respect to word-level input features.

Alternatively, the processor may be further configured to perform the computing of the first set of input attributions by computing the input attributions with respect to sentence-level input features.

The processor may be further configured to measure a quality of the first set of input attributions by using an activation study approach that relates to identifying input features that positively influence the prediction of the decoder-only sequence classification model with respect to a predetermined class.

Alternatively, the processor may be further configured to measure a quality of the first set of input attributions by using an inverse activation study approach that relates to identifying input features that negatively influence the prediction of the decoder-only sequence classification model with respect to a predetermined class.

The decoder-only sequence classification model may include a predetermined large language model (LLM).

According to yet another exemplary embodiment, a non-transitory computer readable storage medium storing instructions for obtaining an explanation of a prediction of a decoder-only sequence classification model is provided. The storage medium includes executable code which, when executed by a processor, causes the processor to: receive a first set of inputs to the decoder-only sequence classification model; generate, based on the first set of inputs, a perturbed version of the first set of inputs; sample a binary mask from a predetermined masking distribution; generate a plurality of masked versions of the perturbed version of the first set of inputs by applying the binary mask to the perturbed version of the first set of inputs; generate, based on the plurality of masked versions of the perturbed version of the first set of inputs, a corresponding plurality of sets of intermediate predictions that correspond to the decoder-only sequence classification model; compute, based on the plurality of sets of intermediate predictions, a first set of input attributions; and determine, based on the first set of input attributions, a first explanation that relates to a prediction of the decoder-only sequence classification model.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for computing input attributions to accurately explain predictions of decoder-only sequence models by using intermediate predictions by evaluating the models at different points in the input sequence.

FIG. 4 is a flowchart of an exemplary process for implementing a method for computing input attributions to accurately explain predictions of decoder-only sequence models by using intermediate predictions by evaluating the models at different points in the input sequence.

FIG. 5 is an illustration of a system that implements a method for computing input attributions to accurately explain predictions of decoder-only sequence models by using intermediate predictions by evaluating the models at different points in the input sequence, according to an exemplary embodiment.

FIG. 6 is a flow diagram that illustrates a single-pass operation of a method for computing input attributions to accurately explain predictions of decoder-only sequence models by using intermediate predictions by evaluating the models at different points in the input sequence, according to an exemplary embodiment.

FIG. 7 is a flow diagram that illustrates a multi-pass operation of a method for computing input attributions to accurately explain predictions of decoder-only sequence models by using intermediate predictions by evaluating the models at different points in the input sequence, according to an exemplary embodiment.

FIG. 8 is an algorithm that is usable in connection with a multi-pass progressive inference aspect of a method for computing input attributions to accurately explain predictions of decoder-only sequence models by using intermediate predictions by evaluating the models at different points in the input sequence, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

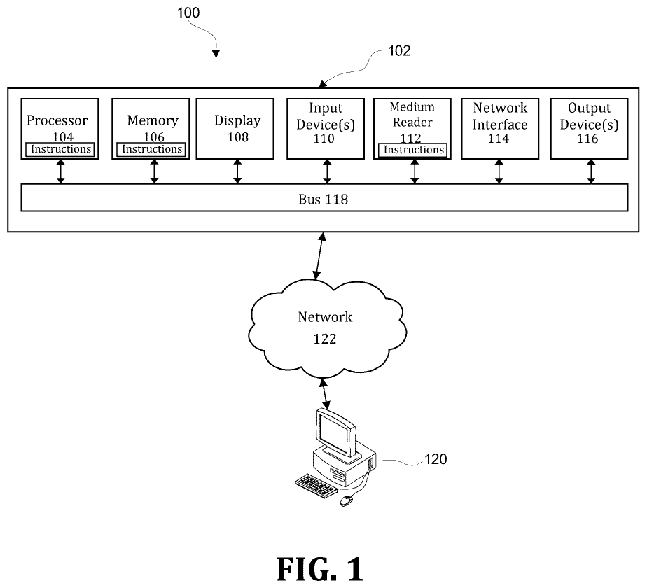

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for computing input attributions to accurately explain predictions of decoder-only sequence models by using intermediate predictions by evaluating the models at different points in the input sequence.

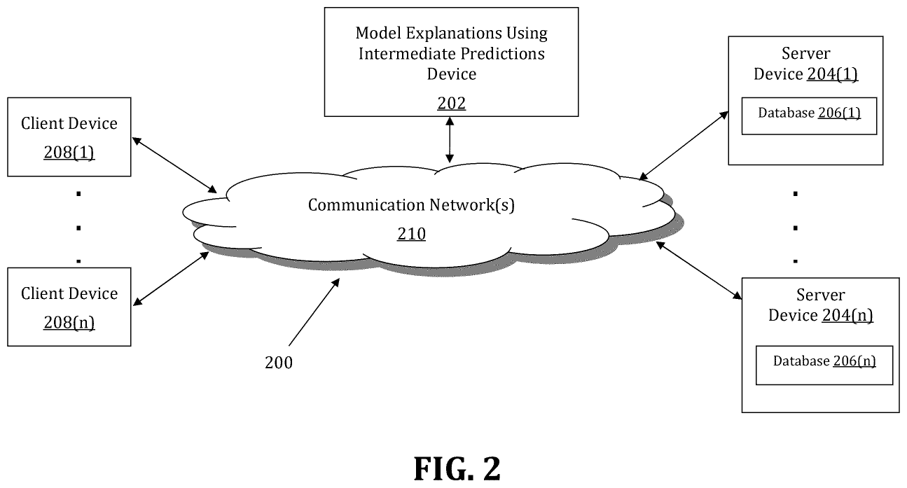

Referring to FIG. 2, a schematic of an exemplary network environment 200 for implementing a method for computing input attributions to accurately explain predictions of decoder-only sequence models by using intermediate predictions by evaluating the models at different points in the input sequence is illustrated. In an exemplary embodiment, the method is executable on any networked computer platform, such as, for example, a personal computer (PC).

The method for computing input attributions to accurately explain predictions of decoder-only sequence models by using intermediate predictions by evaluating the models at different points in the input sequence may be implemented by a Model Explanations Using Intermediate Predictions (MEUIP) device 202. The MEUIP device 202 may be the same or similar to the computer system 102 as described with respect to FIG. 1. The MEUIP device 202 may store one or more applications that can include executable instructions that, when executed by the MEUIP device 202, cause the MEUIP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MEUIP device 202 itself, may be located in virtual server(s) running in a cloud-based computing environment rather than being tied to one or more specific physical network computing devices. Also, the application(s) may be running in one or more virtual machines (VMs) executing on the MEUIP device 202. Additionally, in one or more embodiments of this technology, virtual machine(s) running on the MEUIP device 202 may be managed or supervised by a hypervisor.

In the network environment 200 of FIG. 2, the MEUIP device 202 is coupled to a plurality of server devices 204(1)-204(n) that hosts a plurality of databases 206(1)-206(n), and also to a plurality of client devices 208(1)-208(n) via communication network(s) 210. A communication interface of the MEUIP device 202, such as the network interface 114 of the computer system 102 of FIG. 1, operatively couples and communicates between the MEUIP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MEUIP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MEUIP devices that efficiently implement a method for computing input attributions to accurately explain predictions of decoder-only sequence models by using intermediate predictions by evaluating the models at different points in the input sequence.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MEUIP device 202 may be a standalone device or integrated with one or more other devices or apparatuses, such as one or more of the server devices 204(1)-204(n), for example. In one particular example, the MEUIP device 202 may include or be hosted by one of the server devices 204(1)-204(n), and other arrangements are also possible. Moreover, one or more of the devices of the MEUIP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MEUIP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to historical model outputs and information that relates to metrics for quality and accuracy of explanations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MEUIP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MEUIP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MEUIP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MEUIP device 202, the server devices 204(1)-204(n), or the client devices 208(1)-208(n), for example, may be configured to operate as virtual instances on the same physical machine. In other words, one or more of the MEUIP device 202, the server devices 204(1)-204(n), or the client devices 208(1)-208(n) may operate on the same physical device rather than as separate devices communicating through communication network(s) 210. Additionally, there may be more or fewer MEUIP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

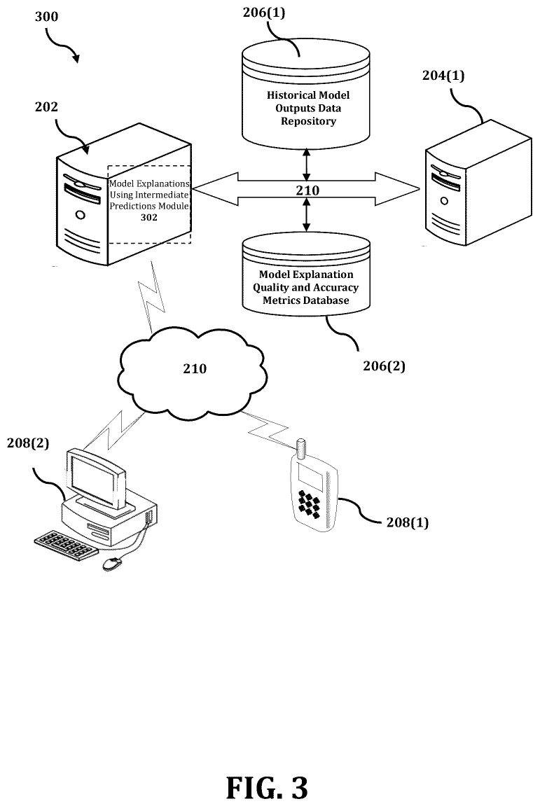

The MEUIP device 202 is described and illustrated in FIG. 3 as including a model explanations using intermediate predictions module 302, although it may include other rules, policies, modules, databases, or applications, for example. As will be described below, the model explanations using intermediate predictions module 302 is configured to implement a method for computing input attributions to accurately explain predictions of decoder-only sequence models by using intermediate predictions by evaluating the models at different points in the input sequence.

An exemplary process 300 for implementing a mechanism for computing input attributions to accurately explain predictions of decoder-only sequence models by using intermediate predictions by evaluating the models at different points in the input sequence by utilizing the network environment of FIG. 2 is illustrated as being executed in FIG. 3. Specifically, a first client device 208(1) and a second client device 208(2) are illustrated as being in communication with MEUIP device 202. In this regard, the first client device 208(1) and the second client device 208(2) may be “clients” of the MEUIP device 202 and are described herein as such. Nevertheless, it is to be known and understood that the first client device 208(1) and/or the second client device 208(2) need not necessarily be “clients” of the MEUIP device 202, or any entity described in association therewith herein. Any additional or alternative relationship may exist between either or both of the first client device 208(1) and the second client device 208(2) and the MEUIP device 202, or no relationship may exist.

Further, MEUIP device 202 is illustrated as being able to access a historical model outputs data repository 206(1) and a model explanation quality and accuracy metrics database 206(2). The model explanations using intermediate predictions module 302 may be configured to access these databases for implementing a method for computing input attributions to accurately explain predictions of decoder-only sequence models by using intermediate predictions by evaluating the models at different points in the input sequence.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MEUIP device 202 via broadband or cellular communication. Of course, these embodiments are merely exemplary and are not limiting or exhaustive.

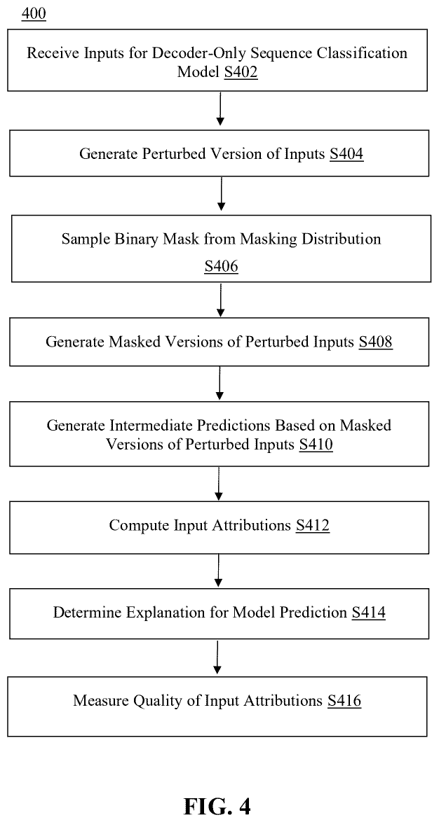

Upon being started, the model explanations using intermediate predictions module 302 executes a process for computing input attributions to accurately explain predictions of decoder-only sequence models by using intermediate predictions by evaluating the models at different points in the input sequence. An exemplary process for computing input attributions to accurately explain predictions of decoder-only sequence models by using intermediate predictions by evaluating the models at different points in the input sequence is generally indicated at flowchart 400 in FIG. 4.

In process 400 of FIG. 4, at step S402, the model explanations using intermediate predictions module 302 receives a first set of inputs for a decoder-only sequence classification model. In an exemplary embodiment, the decoder-only sequence classification model may include a predetermined large language model (LLM), such as, for example, a GPT-2 model or a Llama-2 model that is trained for various types of tasks, such as generating movie reviews; generating news articles that relate to world events, sports, business, or science; generating social media posts that relate to bullish, bearish, or neutral market commentaries; generating social media posts that express positive, negative, or neutral sentiments; or generating social media posts that express anger, joy, optimism, or sadness emotions.

At step S404, the model explanations using intermediate predictions module 302 generates a perturbed version of the inputs received in step S402. Then, at step S406, the model explanations using intermediate predictions module 302 samples a binary mask from a predetermined masking distribution, in order to generate a mask that is usable for creating a variety of coalitions of features from among the perturbed inputs.

At step S408, the model explanations using intermediate predictions module 302 applies the mask generated in step S406 to the perturbed inputs generated in step S404 in order to generate a set of masked versions of the perturbed inputs, such that each masked version of the perturbed inputs includes a coalition of features that corresponds to a subset of the perturbed inputs. In an exemplary embodiment, model explanations using intermediate predictions module 302 may then filter the set of masked versions of the perturbed inputs in order to remove duplicates.

In an exemplary embodiment, it is desirable to generate a mask that is designed to create coalitions of features that follow a Shapley distribution. Accordingly, in an exemplary embodiment, the sampling of the binary mask may include applying a predetermined optimization algorithm to the predetermined masking distribution in order to minimize a distance between the filtered set of masked versions of the perturbed inputs and a Shapley distribution of subsets of the perturbed inputs.

At step S410, the model explanations using intermediate predictions module 302 uses the set of masked versions of the perturbed inputs to generate a corresponding set of intermediate predictions that correspond to the decoder-only sequence classification model. In this aspect, the use of more than one masked version of the perturbed inputs has the effect of executing multiple passes of the model in order to generate a corresponding multiplicity of intermediate predictions that is based on a variety of coalitions of features, and this eventually results in a more robust and accurate explanation for the model prediction. However, in an alternative exemplary embodiment, when a single-pass approach is used in order to minimize computational load, a single set of intermediate predictions is generated, and this single set of intermediate predictions is also usable for eventually obtaining an explanation for the model prediction.

At step S412, the model explanations using intermediate predictions module 302 uses the intermediate predictions generated in step S410 to compute a set of input attributions. In an exemplary embodiment, the input attributions may be computed with respect to word-level input features. Alternatively, in another exemplary embodiment, the input attributions may be computed with respect to sentence-level input features.

When the single-pass approach is being used, the input attributions may be computed by computing a set of respective differences between successive pairs of the intermediate predictions generated in step S410. When the multi-pass approach is being used, the input attributions may be computed by applying a Kernel Shapley Additive exPlanations (i.e., Kernel SHAP) algorithm to the filtered set of masked versions of the perturbed inputs and the corresponding intermediate predictions.

At step S414, the model explanations using intermediate predictions module 302 uses the input attributions computed in step S412 to generate an explanation that relates to a prediction of the decoder-only sequence classification model. Then, at step S416, the model explanations using intermediate predictions module 302 measures a quality of the input attributions in order to provide an indication of the robustness and accuracy of the explanation. In an exemplary embodiment, the quality of the input attributions may be measured by using an activation study approach that relates to identifying input features that positively influence the prediction of the model with respect to a predetermined class. In an alternative exemplary embodiment, the quality of the input attributions may be measured by using an inverse activation study approach that relates to identifying input features that negatively influence the prediction of the model with respect to the predetermined class.

In an exemplary embodiment, an objective of the present inventive concept is to provide a framework that generates high-quality explanations for decoder-only Transformer models by leveraging the unique properties of an architecture that uses intermediate predictions to compute input attributions with respect to a model. To this end, an observation is made that decoder-only models that are trained autoregressively use the masked self-attention mechanism. This mechanism enforces the property that the prediction of the model ant any position depends solely on the tokens seen at or before that position. One key insight is that this property can be exploited to obtain the model's predictions on perturbed versions of the input, which can then be used to compute token/word/sentence-level attributions.

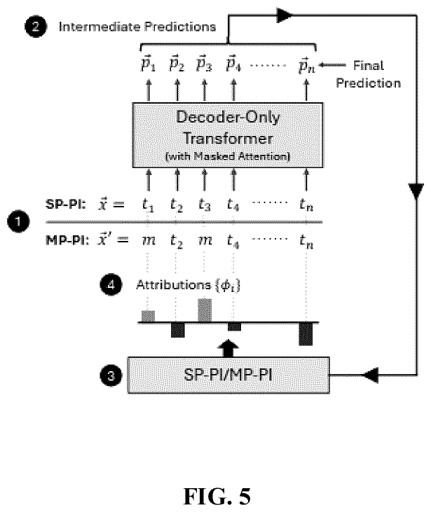

FIG. 5 is an illustration 500 of a system that implements a method for computing input attributions to accurately explain predictions of decoder-only sequence models by using intermediate predictions by evaluating the models at different points in the input sequence, according to an exemplary embodiment. As illustrated in FIG. 5, when passed through the decoder, the input sequence {t₁, t₂, . . . , tₙ}produces the predictions {\vec{p₁}, \vec{p₂}, . . . , \vec{pₙ}}. Due to the masked attention mechanism, the prediction at the i-th position \vec{pᵢ} only depends on tokens {t₁, t₂, . . . , tₙ}, which appear at or before the i-th position. As such, pᵢ can be treated as the model's prediction on a perturbed and/or masked version of the input, where only the tokens/features {t₁, t₂, . . . , tₙ} are active and the remaining tokens {t₁, t₂, . . . , tₙ} are masked out. Thus, simply by computing the intermediate predictions, the model's prediction is obtainable on n perturbed versions of the input, for almost no extra cost.

In an exemplary embodiment, a framework referred to herein as progressive inference is provided, in order to produce highly-faithful explanations using the intermediate predictions from decoder-only models. Two approaches that can be used under different compute budgets to explain decoder-only sequence classification models are proposed.

The first approach is referred to herein as Single-Pass Progressive Inference (SP-PI). SP-PI computes attributions over input features by taking the difference between consecutive intermediate predictions. This technique does not require additional forward passes and incurs negligible computational overheads to compute intermediate predictions. Despite its simplicity, it has been observed that it yields attributions that are on par or better than previous explainable artificial intelligence (XAI) techniques that have a comparable amount of computational overhead.

The second approach is referred to herein as Multi-Pass Progressive Inference (MP-PI). A key limitation of SP-PI is that it does not have any control over the distribution of the masked inputs. For example, as illustrated in FIG. 5, SP-PI only provides predictions associated with masked inputs, where the set of active features are of the form {t₁, t₂, . . . , tₙ}. It is not possible to obtain a prediction on a masked input with an arbitrary set of active features, such as, for example, {t₁, t₄, t₉}. MP-PI solves this problem by performing multiple inference passes with several randomly sampled masked versions of the input. Each inference pass yields intermediate predictions corresponding to a new set of perturbed inputs. To compute attributions to these predictions, it is noted that intermediate predictions can be used to solve a weighted regression problem to compute input attributions. These attributions may be approximated by applying a SHapley Additive exPlanations (SHAP) technique to generate SHAP values if the intermediate masks follow the Shapley distribution. To this end, an optimization problem is designed to find a probability distribution for sampling input masks, which results in the intermediate masks following the Shapley distribution. As a result of its principled formulation, MP-PI provides SHAP-like attributions that more accurately reflect the behavior of the model, as compared with SP-PI and previous works.

Consider a model ∫: [symbol] ⁿ→ [symbol] ^{k} that is trained to perform a k-class classification task. Let N={1,2, . . . , n} denote the set of feature indices and \vec{x}=[t₁, t₂, . . . , tₙ] denote the input vector, where tᵢ represents the i^{th} feature/token. The goal of input-attributions techniques is to compute a set of feature-level attributions \vec{ϕ}=[ϕ₁, ϕ₂, . . . , ϕₙ] that reflects the influence of each feature on the prediction of the model. These attributions can either be computed for each token or groups of tokens that respectively represent words or sentences.

Perturbation-based methods are based on the idea that the importance of input features can be measured by examining how the prediction of the model changes for different perturbed versions of the input. One formulation of this idea is the SHAP framework that computes input attributions by using a game-theoretic approach that views input features as players and the prediction of the model as the outcome in a collaborative game. The attribution ϕᵢ for the i^{th} feature can be computed by taking a weighted average of the marginal contributions of the i^{th} feature, when added to different coalitions of features S, as shown in the following expression:

$${ϕ}_{i} = {\sum }_{S ⊆ N \backslash \{ i \}} \frac{\vert S \vert ! ( n - \vert S \vert - 1 ) !}{n !} [ f ( {x}_{S ⋃ \{ i \}} ) - f ( {x}_{S} ) ] \qquad ( Equation 1 )$$

The feature attributions computed in this manner are referred to as SHAP values, and have been shown to satisfy several desirable axiomatic properties, such as local-accuracy, missingness, and consistency. Because the number of terms in the SHAP equation increases exponentially with the number of input features, computing the SHAP equation exactly is intractable when there are a large number of features in the input. To mitigate this issue, sampling-based methods such as samplingSHAP and Kernel SHAP have been proposed to compute approximate SHAP values in a tractable way. SamplingSHAP simply evaluates a subset of the terms in Equation 1, whereas Kernel SHAP uses the idea that SHAP values can be viewed as a solution to the following weighted linear regression problem:

$$\{ {ϕ}_{i} \} = {arg min}_{{ϕ}_{1} , .. {ϕ}_{d}} {\sum }_{S ⊆ N} w ( S ) {( f ( {t}_{S} ) - g ( S ) )}^{2} \qquad ( Equation 2 )$$

$$where , g ( S ) = {ϕ}_{0} + {\sum }_{i ∈ S} {ϕ}_{i} . \qquad ( Equation 3 )$$

In an exemplary embodiment, a progressive inference (PI) framework is provided for computing input attributions to explain the predictions of decoder-only models. PI exploits the key observation that the intermediate predictions of a decoder-only based model only depend on the tokens that appear at or before that position. This observation is used to interpret intermediate predictions as representing the prediction of the model on masked versions of the input.

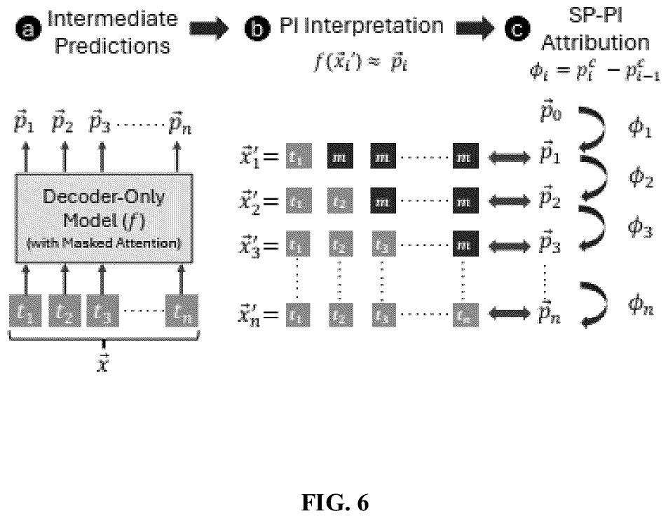

FIG. 6 is a flow diagram 600 that illustrates a single-pass operation of a method for computing input attributions to accurately explain predictions of decoder-only sequence models by using intermediate predictions by evaluating the models at different points in the input sequence, according to an exemplary embodiment. Referring to FIG. 6, an input x=[t₁, t₂, . . . , tₙ] is passed through the model ƒ to produce the intermediate predictions {\vec{p₁}, \vec{p₂}, . . . \vec{pₙ}}. Due to the masked attention mechanism, the intermediate predictions {\vec{p₁}, \vec{p₂}, . . . , \vec{pₙ}} may be viewed intuitively as representing the predictions of the model on the masked inputs [t₁, m, . . . , m], [t₁, t₂, . . . , m], . . . , [t₁, t₂, . . . tₙ] respectively. More formally, A may be interpreted as an approximation of the model's prediction on perturbed/masked version of the original input as follows:

\vec{pᵢ}≈∫(\vec{x}ᵢ′), (Equation 4)

where

\vec{x}ᵢ′=hₓ(\vec{z}ᵢ)=\vec{z}ᵢ×\vec{x}+(1−\vec{z}ᵢ)×m. (Equation 5).

Here, \vec{zᵢ} is a binary mask vector which indicates the features that are active in the perturbed input \vec{x}ₓ′as shown in FIG. 6. To reflect the masked attention mechanism, \vec{zᵢ} is set to be the i^{th} row of a n×n lower triangular matrix of ones [symbol] ₁. hₓ: [symbol] → [symbol] is a masking function that maps the binary mask to the masked input as defined in Equation 5 above. m denotes the mask token that is used to replace inactive tokens.

Using the above interpretation, with a single forward pass of the model, it is possible to obtain the prediction of the model on up ton perturbed inputs: {\vec{x}ᵢ′, \vec{p}ᵢ)}. This set of (\vec{x}ᵢ′, \vec{p}ᵢ) pairs may then be used to compute input attributions that explain the prediction of the model.

SP-PJ: SP-PI requires a single forward pass with the original input \vec{x}. Let \vec{p}ᵢ=[pₓ¹, pᵢ², . . . , pᵢ^{k}] denote the logit-vector associated with the i^{th} intermediate prediction. To explain the model's prediction on class c, SP-PI computes attribution by taking the difference between successive intermediate predictions as follows:

$${ϕ}_{i} = {p}_{i}^{c} - {p}_{i - 1}^{c} \qquad ( Equation 6 )$$

It is noted that the attribution ϕᵢ can be viewed as the marginal change in the prediction of the model, when the i^{th} feature is added to the coalition of features Sᵢ₋₁={1, 2, . . . , i−1} that came before it. This can be seen more clearly by using Equations 4 and 5 above to rewrite Equation 6 as follows:

$${ϕ}_{i} \approx {f}^{c} ( {\vec{x}}_{i}^{′} ) - {f}^{c} ( {\vec{x}}_{i - 1}^{′} ) , \qquad ( Equation 7 )$$

$${ϕ}_{i} \approx {f}^{c} ( {h}_{x} ( {\vec{z}}_{{\overline{S}}_{i - 1} {⋃}_{i}} ) ) - {f}^{c} ( {h}_{x} ( {\vec{z}}_{{\overline{S}}_{i - 1}} ) ) . \qquad ( Equation 8 )$$

Here, S denotes a set of active features and: denotes the corresponding binary mask vector such that z_{S}^{j}=[1 for j ∈ S, and 0 otherwise].

Both SHAP and SP-PI compute attributions by evaluating the change in the prediction of the model by adding a feature to a coalition of features. SHAP computes feature attribution by considering the weighted average of the marginal contribution of a feature across multiple coalitions. In contrast, SP-PI computes attribution by only considering a single coalition. While both SP-PI and SHAP satisfy desirable axiomatic properties such as local accuracy, the quality of attributions computed with SP-PI falls short of SHAP values as SP-PI only considers a single coalition.

A key limitation of SP-PI is that, in order to compute ϕᵢ, it considers a single coalition of features of the form Sᵢ₋₁={1, 2, 3, . . . , i−1}, i.e., the set of all features that appear before the i^{th} feature. This effectively prevents an evaluation of the marginal contribution on arbitrary subsets of features. To bridge this gap, multi-pass progressive inference (MP-PI) is provided.

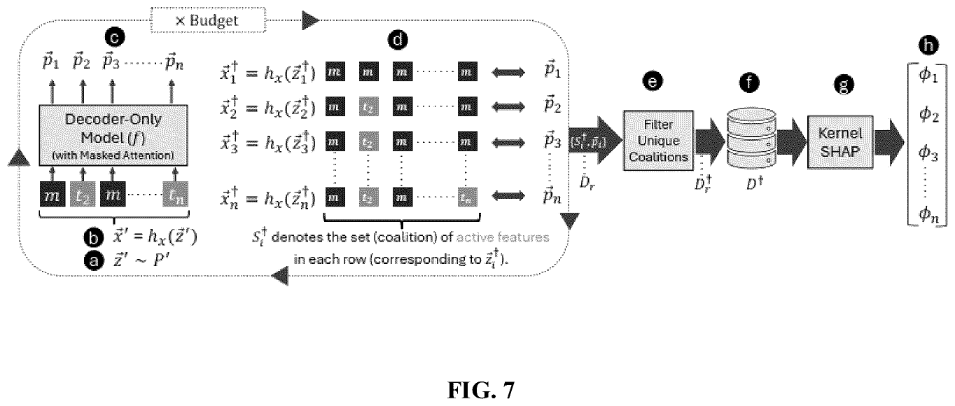

MP-PI: MP-PI performs multiple rounds of progressive inference, each time with a different masked version of the input, thereby allowing for an ability to sample a more diverse coalition of features. FIG. 7 is a flow diagram 700 that illustrates a multi-pass operation of a method for computing input attributions to accurately explain predictions of decoder-only sequence models by using intermediate predictions by evaluating the models at different points in the input sequence, according to an exemplary embodiment.

As illustrated in FIG. 7, each round starts by sampling a binary mask \vec{z} from a pre-defined masking distribution. This binary mask \vec{z} is used to obtain a masked version of the input \vec{x}′=hₓ(\vec{z}). Inference is performed on this masked input to obtain a set of intermediate predictions {\vec{p}ᵢ}. Using the PI interpretation yields the following expressions:

$${\vec{p}}_{i} \approx f ( {\vec{x}}_{i}^{†} ) , \qquad ( Equation 9 )$$

$$where {\vec{x}}_{i}^{†} = {h}_{x} ( {\vec{z}}_{i}^{†} ) , {\vec{z}}_{i}^{†} = {\vec{z}}^{′} ⊙ {\vec{z}}_{i} . \qquad ( Equation 10 )$$

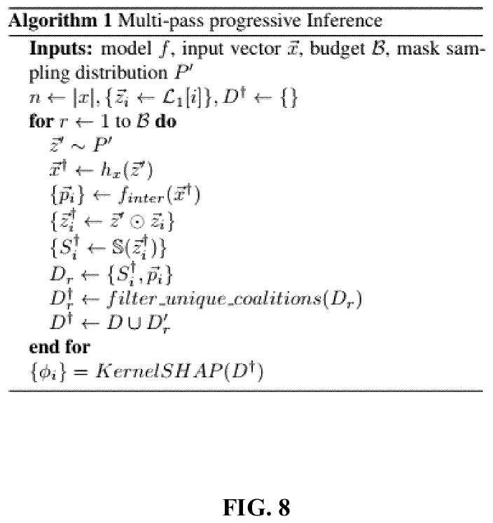

Here, \vec{x}′ᵢ denotes the perturbed input corresponding to, \vec{p}ᵢ and \vec{z}′ᵢ is the binary mask applied to \vec{x} to produce \vec{x}′ᵢ, \vec{z}′ᵢ can be expressed as the Hadamard product of \vec{z}, which is the masking vector used to produce \vec{x}, and \vec{z}ᵢ, which is the i^{th} row of L₁, which is the lower triangular matrix of ones. Sᵢ^{†} is used to denote the set of active features in \vec{z}ᵢ^{†}. Let Dᵣ represent the set {sᵢ^{†}, \vec{p}ᵢ} collected in the r^{th} round. Note that Dᵣ can have redundant coalitions; for example, as shown in FIG. 7, S₂ and S₃ have the same set of features. Dᵣ is filtered to only retain unique coalitions to create Dᵣ^{†}. The Dᵣ^{†} from each round are combined to construct the dataset D^{†}. Kernel SHAP is then used with this dataset to compute the feature attributions {ϕᵢ}. This procedure is also more formally described in Algorithm 1 as shown in FIG. 8.

FIG. 8 is an algorithm 800 that is usable in connection with a multi-pass progressive inference aspect of a method for computing input attributions to accurately explain predictions of decoder-only sequence models by using intermediate predictions by evaluating the models at different points in the input sequence, according to an exemplary embodiment.

Using Kernel SHAP to Compute ϕᵢ: Kernel SHAP starts by defining a linear model

g(S)=ϕ₀+Σ_{i∈S}^{ϕi},

where S⊆N denotes a coalition of input features. The coefficients {ϕᵢ} are optimized using the dataset D^{†} by solving the weighted linear regression problem as follows:

$$\{ {ϕ}_{i}^{*} \} = {arg min}_{{ϕ}_{1} , .. {ϕ}_{n}} {\sum }_{( {S}_{i}^{†} , {\vec{p}}_{i} ) ∈ {D}^{†}} w ( {S}_{i}^{†} ) {( {p}_{i}^{c} - g ( {S}_{i}^{†} ) )}^{2} . \qquad ( Equation 11 )$$

If the coalitions in D^{†} are sampled independently and their distribution, denoted by P^{D}, follows the Shapley distribution P*, then the solution {ϕᵢ^{*}}, obtained by optimizing Equation 11 with uniform weights ω(Sᵢ^{†}), represent the SHAP values. Unfortunately, the samples in D^{†} are not independently sampled. However, there is an ability to control P^{D} by carefully selecting the distribution of masks P′, which is used to generate the perturbed inputs \vec{x}′, i.e., the masked input to the model in FIG. 7. Thus, for to approximate SHAP values, it is important to find an optimal P′ that results in following the Shapley distribution P*.

Optimizing P′: The optimization process starts by introducing notation to express the Shapley distribution P* and the input masking distribution P′. Then, a connection is established between P′ and P^{D} as a distribution of intermediate coalitions. Finally, an optimization procedure is formulated to find the P′ that minimizes the distance between P^{D} and P*.

Notations for P*: The Shapley distribution can be expressed in a vector form as [P₁, P₂*, . . . , Pₙ₋₁*], where

$${P}_{i}^{*} = \frac{1}{Ci ( n - i )}$$

denotes the probability of sampling a coalition of size i. Here,

$$C = {\sum }_{i} \frac{1}{i ( n - i )}$$

is the normalization constant that ensures that

ΣᵢPᵢ*=1.

Alternatively, P* can also be expressed as a (n−1)×n matrix, where each entry of the matrix P*ᵢⱼ indicates the probability of sampling coalitions of size i, where j is the last active feature. More formally, this may be written as follows:

$${P}_{ij}^{*} = Pr ( {S}_{ij} : \vert {S}_{ij} \vert = i , j ∈ {S}_{ij} , ∀ k ∈ N / {S}_{ij} , k > j ) . \qquad ( Equation 12 )$$

Note that Sᵢⱼ does not refer to any single coalition of features, as there are multiple coalitions that could satisfy the conditions for S, in Equation 12. Then, P*ᵢⱼ is expressible in terms of P*ᵢ as follows:

$${P}_{ij}^{*} = \{ \begin{matrix}{P}_{i}^{*} ( \begin{matrix}j - 1 \\ i - 1\end{matrix} ) / ( \begin{matrix}n \\ i\end{matrix} ) & if j \geq i \\ 0 & otherwise\end{matrix} . \qquad ( Equation 13 )$$

Notations for P′: Similarly, the masking distribution P′ is expressible as a (n−1)×n matrix consisting of entries P′ᵢⱼ that indicate the probability of sampling coalitions of the form Sᵢⱼ, where

|Sᵢⱼ|=i

and j is the last active feature.

Connecting P′ and P^{D}: In the PI framework, predictions on an input coalition S′ᵢⱼ, which represent the input \vec{x}′ in FIG. 7, yield additional predictions for coalitions of the form

{Sₖₗ^{†}}ₖ₌₁ⁱ,

i.e., coalitions of sizes 1, 2, . . . , i, as represented by Dᵣ^{†} in FIG. 7. The distributions of these additional coalitions Sₖₗ^{†} may be viewed as being conditioned on S′ᵢⱼ. Assuming i, j, k, l, ∈ N, this conditional distribution is given by the following expression:

$${P}_{kl \vert ij}^{†} = \{ \begin{matrix}( \begin{matrix}l - 1 \\ k - 1\end{matrix} ) ( \begin{matrix}j - l \\ i - k\end{matrix} ) / ( ( \begin{matrix}j - 1 \\ i - 1\end{matrix} ) i ) & if k \leq i , l \leq j , j \geq i \\ 0 & otherwise .\end{matrix} . \qquad ( Equation 14 )$$

There are n(n−1) values for i, j and k, l. Thus, P_{kl|ij}^{†} can be written as a n(n−1)×n(n−1) matrix. This conditional distribution matrix can then be used to express P^{D} in terms of P′ as follows:

$${\vec{P}}^{D} = {\vec{P}}^{′} {P}_{kl \vert ij}^{†} . \qquad ( Equation 15 )$$

Here, \vec{P}^{D} and \vec{P}′ are the vectorized representation of the matrices P^{D} and P′. In an exemplary embodiment, an objective is to optimize P′ to minimize the distance between P^{D} and P*. This may be accomplished by solving the following optimization problem:

$${P}^{′} = {arg min}_{{P}^{′}} \vert {\vec{P}}^{′} {P}_{kl \vert ij}^{†} - {\vec{P}}^{*} \vert s . t . {P}_{ij}^{′} \geq 0. \qquad ( Equation 16 )$$

It is noted that the P′ obtained from Equation 16 may not result in P^{D} exactly matching P*. This issue may be remedied by setting

ω(Sᵢⱼ)=P*/P^{D}

in Equation 2 when computing the attributions with Kernel SHAP.

Maximizing the Number of Samples: While the procedure described above is sufficient to find SHAP-like attributions, it is also possible to perform an additional optimization to maximize the number of coalitions that are obtainable when running MP-PI. As an initial step, it is noted that the intermediate coalitions s obtained by a set of input coalitions N is a subset of the intermediate coalitions obtained by the input coalition S′ᵢⱼ is a subset of the intermediate coalitions obtained by the input coalition

Sᵢⱼ^{†}=S′ᵢⱼ∪{j+1,j+2, . . . ,n},

where n is the total number of input features. To illustrate, consider the input coalition S′={1, 3, 4}, with n=6. By running PI with S′, three unique coalitions are obtained: {S^{†}}: {{1}{1, 3}{1, 3, 4}}Instead, if S′ is modified to include {5, 6), i.e., S⁺={1, 3, 4, 5, 6), then the following unique intermediate coalitions are obtained with PI: {S^{†}}: {{1}, {1,3}, {1,3,4}, {1,3,4,5}, {1,3,4,5,6}}. Note that this contains all of the coalitions provided by S′, and two extra coalitions: {1, 3, 4, 5} and {1, 3, 4, 5, 6}.

To maximize the number of coalitions, S⁺ᵢⱼ is used in MP-PI instead of S′ᵢⱼ. Due to this modification, the conditional distribution in Equation 14 changes to the following:

$${P}_{kl \vert ij}^{†} = \{ \begin{matrix}( \begin{matrix}l - 1 \\ k - 1\end{matrix} ) ( \begin{matrix}j - l \\ i - k\end{matrix} ) / ( ( \begin{matrix}j - 1 \\ i - 1\end{matrix} ) {i}^{′} ) & if k < i , l < j , j \geq i \\ 1 / {i}^{′} & if l \geq j , k = i + l - j \\ 0 & otherwise\end{matrix} . \qquad ( Equation 17 )$$

Here,

i′(i+n−j),

which denotes the total number of active features in S⁺ᵢⱼ. Then, the conditional distribution in Equation 17 is used instead of the one in Equation 14 to optimize P′.

Measuring the Quality of Attributions: In an exemplary embodiment, a random sampling of examples from the test set of any particular dataset may be obtained, e.g., a random sampling of 500 such examples; and the random sampling may then be used to compute attributions to explain the prediction of the model on the true class c with these examples. To quantify the quality of explanations, two types of studies may be performed with the attributions.

Activation Study: An activation study measures the ability of attributions to identify input features that increase, or positively influence, the prediction of the model on the selected class. The activation study works by sorting the input features in a descending order of attribution values

N_{AS}=argsort({−ϕᵢ}),

i.e., most positive to most negative. It then creates a fully masked version of the input and incrementally adds individual features from N_{AS}. It is noted that the prediction of the model changes as new features are added. The probability corresponding to the correct class is plotted as a function of the number of features added, and the area under the curve (AUC) of this plot can be used to measure the quality of attribution.

Inverse Activation Study: In contrast to the activation study, an inverse activation study measures the ability of attributions to identify input features that reduce, or negatively influence, the prediction of the model on the selected class. Identifying such features is especially useful in the event of a misprediction, i.e., to override or debut the prediction of the model. The inverse activation study works by sorting features in an increasing order of attribution values

N_{IAS}=argsort({ϕᵢ}),

i.e., most negative to most positive. It then measures the AUC of the curve obtained by plotting the prediction of the model on the correct class ƒ^{c}(x′). A lower AUC indicates better performance for the inverse activation study, because features with negative influence are added first.

Accordingly, with this technology, an optimized process for computing input attributions to accurately explain predictions of decoder-only sequence models by using intermediate predictions by evaluating the models at different points in the input sequence is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for obtaining an explanation of a prediction of a decoder-only sequence classification model, the method being implemented by at least one processor, the method comprising:
receiving a first set of inputs to the decoder-only sequence classification model;
generating, based on the first set of inputs, a first set of intermediate predictions that correspond to the decoder-only sequence classification model;
estimating, based on the first set of intermediate predictions, a second set of intermediate predictions that relates to a perturbed version of the first set of inputs;
computing, based on the second set of intermediate predictions, a first set of input attributions; and
determining, based on the first set of input attributions, a first explanation that relates to a prediction of the decoder-only sequence classification model.

2. The method of claim 1, wherein the computing of the first set of input attributions comprises computing a set of respective differences between successive pairs of intermediate predictions within the second set of intermediate predictions.

3. A method for obtaining an explanation of a prediction of a decoder-only sequence classification model, the method being implemented by at least one processor, the method comprising:
receiving a first set of inputs to the decoder-only sequence classification model;
generating, based on the first set of inputs, a perturbed version of the first set of inputs;
sampling a binary mask from a predetermined masking distribution;
generating a plurality of masked versions of the perturbed version of the first set of inputs by applying the binary mask to the perturbed version of the first set of inputs;
generating, based on the plurality of masked versions of the perturbed version of the first set of inputs, a corresponding plurality of sets of intermediate predictions that correspond to the decoder-only sequence classification model;
computing, based on the plurality of sets of intermediate predictions, a first set of input attributions; and
determining, based on the first set of input attributions, a first explanation that relates to a prediction of the decoder-only sequence classification model.

4. The method of claim 3, further comprising filtering the plurality of masked versions of sets of the perturbed version of the first set of inputs in order to remove duplicative masked versions of sets of the perturbed version of the first set of inputs.

5. The method of claim 4, wherein the computing of the first set of input attributions comprises applying a Kernel SHapley Additive exPlanations (SHAP) algorithm to the filtered plurality of masked versions of sets of the perturbed version of the first set of inputs and the corresponding plurality of sets of intermediate predictions.

6. The method of claim 5, wherein the sampling of the binary mask comprises applying a predetermined optimization algorithm to the predetermined masking distribution in order to minimize a distance between the filtered plurality of masked versions of sets of the perturbed version of the first set of inputs and a Shapley distribution of subsets of the perturbed version of the first set of inputs.

7. The method of claim 3, wherein the computing of the first set of input attributions comprises computing the input attributions with respect to word-level input features.

8. The method of claim 3, wherein the computing of the first set of input attributions comprises computing the input attributions with respect to sentence-level input features.

9. The method of claim 3, further comprising measuring a quality of the first set of input attributions by using an activation study approach that relates to identifying input features that positively influence the prediction of the decoder-only sequence classification model with respect to a predetermined class.

10. The method of claim 3, further comprising measuring a quality of the first set of input attributions by using an inverse activation study approach that relates to identifying input features that negatively influence the prediction of the decoder-only sequence classification model with respect to a predetermined class.

11. The method of claim 3, wherein the decoder-only sequence classification model comprises a predetermined large language model (LLM).

12. A computing apparatus for obtaining an explanation of a prediction of a decoder-only sequence classification model, the computing apparatus comprising:
a processor;
a memory; and
a communication interface coupled to each of the processor and the memory,
wherein the processor is configured to:
receive, via the communication interface, a first set of inputs to the decoder-only sequence classification model;
generate, based on the first set of inputs, a perturbed version of the first set of inputs;
sample a binary mask from a predetermined masking distribution;
generate a plurality of masked versions of the perturbed version of the first set of inputs by applying the binary mask to the perturbed version of the first set of inputs;
generate, based on the plurality of masked versions of the perturbed version of the first set of inputs, a corresponding plurality of sets of intermediate predictions that correspond to the decoder-only sequence classification model;
compute, based on the plurality of sets of intermediate predictions, a first set of input attributions; and
determine, based on the first set of input attributions, a first explanation that relates to a prediction of the decoder-only sequence classification model.

13. The computing apparatus of claim 12, wherein the processor is further configured to filter the plurality of masked versions of sets of the perturbed version of the first set of inputs in order to remove duplicative masked versions of sets of the perturbed version of the first set of inputs.

14. The computing apparatus of claim 13, wherein the processor is further configured to compute the first set of input attributions by applying a Kernel SHapley Additive exPlanations (SHAP) algorithm to the filtered plurality of masked versions of sets of the perturbed version of the first set of inputs and the corresponding plurality of sets of intermediate predictions.

15. The computing apparatus of claim 14, wherein the processor is further configured to perform the sampling of the binary mask by applying a predetermined optimization algorithm to the predetermined masking distribution in order to minimize a distance between the filtered plurality of masked versions of sets of the perturbed version of the first set of inputs and a Shapley distribution of subsets of the perturbed version of the first set of inputs.

16. The computing apparatus of claim 12, wherein the processor is further configured to perform the computing of the first set of input attributions by computing the input attributions with respect to word-level input features.

17. The computing apparatus of claim 12, wherein the processor is further configured to perform the computing of the first set of input attributions by computing the input attributions with respect to sentence-level input features.

18. The computing apparatus of claim 12, wherein the processor is further configured to measure a quality of the first set of input attributions by using an activation study approach that relates to identifying input features that positively influence the prediction of the decoder-only sequence classification model with respect to a predetermined class.

19. The computing apparatus of claim 12, wherein the processor is further configured to measure a quality of the first set of input attributions by using an inverse activation study approach that relates to identifying input features that negatively influence the prediction of the decoder-only sequence classification model with respect to a predetermined class.

20. The computing apparatus of claim 12, wherein the decoder-only sequence classification model comprises a predetermined large language model (LLM).
